(19) United States
(12) Patent Application Publication
(10) Pub. No.: US 2016/0146673 A1
(43) Pub. Date: May 26, 2016

(54) TEMPERATURE INDICATING SYSTEM

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: GE HE, Wuhan (CN); YI-LIANG LI, Wuhan (CN); YU-LIN LIU, Wuhan (CN)

(21) Appl. No.: 14/585,541

(22) Filed: Dec. 30, 2014

(30) Foreign Application Priority Data
Nov. 21, 2014 (CN) 201410671445.2

(51) Int. Cl. G01K 1/02

(52) U.S. Cl. CPC G01K 1/02

(57) ABSTRACT

A temperature indicating system for a vending machine includes a detecting module, a control module coupled to the detecting module, and an indicating module coupled to the control module. The detecting module is configured to receive a temperature signal after detecting a compressor of the vending machine, convert the temperature signal to a temperature value, and send the temperature value to the control module. The control module is configured to control the indicating module to indicate the temperature value.

### CROSS-REFERENCE TO RELATED APPLICATIONS

This application claims priority to Chinese Patent Application No. 201410671445.2 Nov. 21, 2014, the contents of which are incorporated by reference herein.

### FIELD

The subject matter herein generally relates to a temperature indicating system.

### BACKGROUND

A temperature indicating system may be used to indicate an internal temperature of a vending machine.

### BRIEF DESCRIPTION OF THE DRAWINGS

Implementations of the present technology will now be described, by way of example only, with reference to the attached figures.

FIG. 1 is a block diagram of one embodiment of a temperature indicating system.

FIG. 2 is a circuit diagram of one embodiment of the temperature indicating system.

FIG. 3 is a flowchart of one embodiment of the temperature indicating system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to a temperature indicating system to indicate and display an internal temperature of a vending machine.

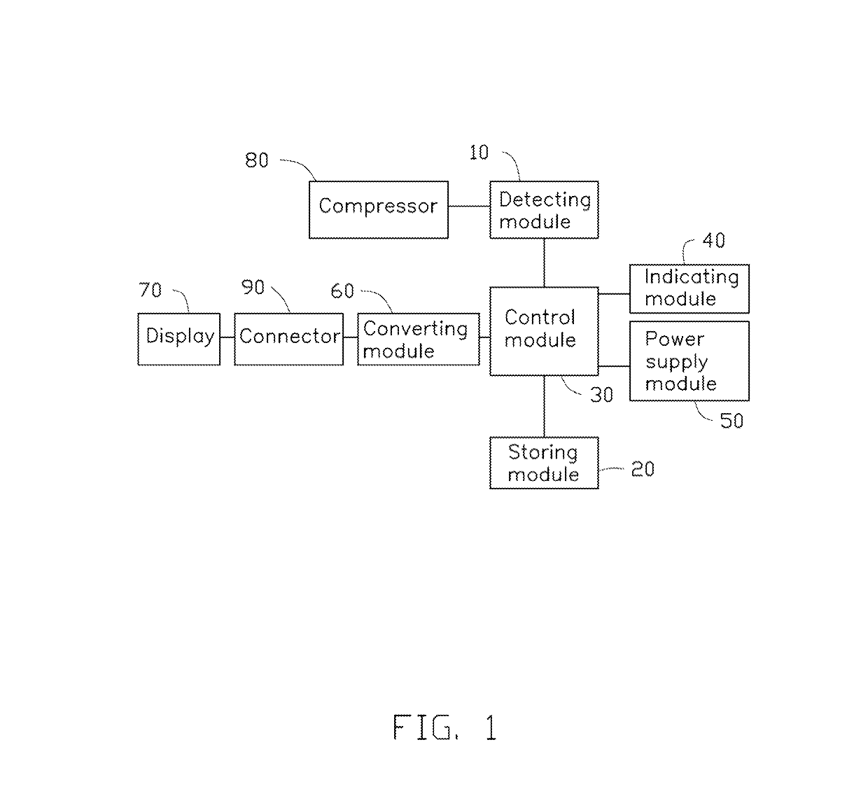

FIG. 1 illustrates one embodiment of a temperature indicating system. The temperature indicating system is used in a vending machine and comprises a detecting module 10, a storing module 20, a control module 30, an indicating module 40, a power supply module 50, and a converting module 60. The control module 30 is configured to couple to a display 70 of a computer via the converting module 60, thereby displaying a temperature value in the display 70.

The detecting module 10 is configured to detect the temperature of a compressor 80 of the vending machine. The detecting module 10 is also configured to transform the temperature signal to a temperature value and send the temperature value to the control module 30. The control module 30 is configured to control the storing module 20 to store the temperature value. The control module 30 is also configured to send the temperature value to the converting module 60. The converting module 60 is configured to transform the temperature value to a display value to display on the display 70. The display 70 is configured to display the temperature of the compressor 80.

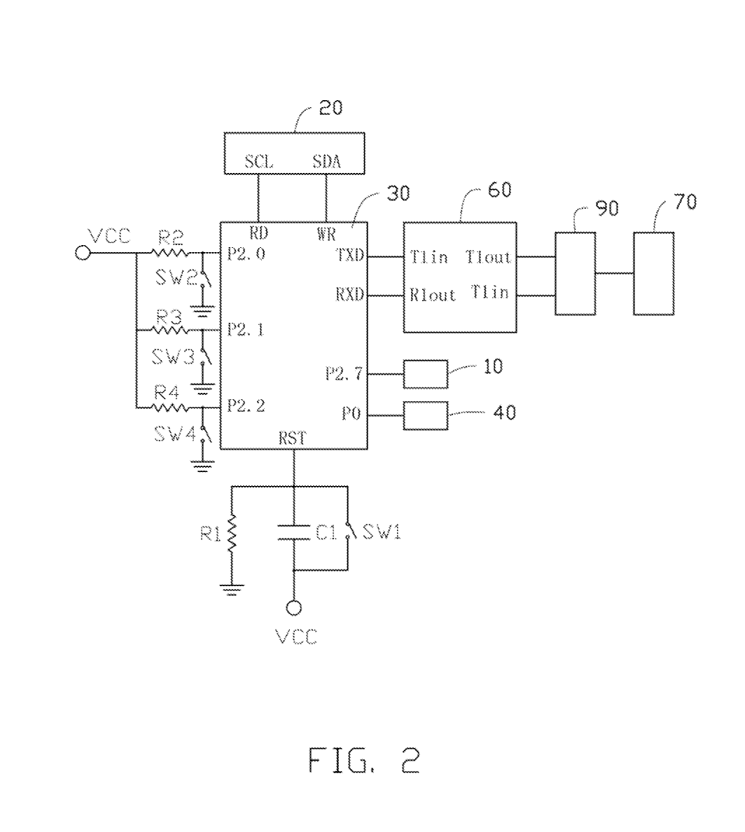

FIG. 2 illustrates that the storing module 20 comprises a data wire pin SDA and a time wire pin SCL. The converting module 60 comprises a first data input pin T1in, a second data input pin R1in, a first data output pin T1out, and a second data output pin R1out. The indicating module 40 comprises three Nixie tubes (not shown) and displays the temperature value via the three Nixie tubes. The control module 30 comprises a reset terminal RST, a sending terminal TXD, a receiving terminal RXD, an output unit P0, an input terminal P2.7, a data reading terminal RD, a data writing terminal WR, a first controlling terminal P2.0, a second controlling terminal P2.1, and a third controlling terminal P2.2.

The reset terminal RST of the control module 30 is grounded via a first resistor R1. The reset terminal RST is coupled to a power supply VCC via a capacitor C1 and via a first switch SW1. The first controlling terminal P2.0 is grounded via a second switch SW2 and is coupled to the power supply VCC via a second resistor R2. The second controlling terminal P2.1 is grounded via a third switch SW3 and is coupled to the power supply VCC via a third resistor R3. The third controlling terminal P2.2 is grounded via a fourth switch SW4 and is coupled to the power supply VCC via a fourth resistor R4. The receiving terminal RXD is coupled to the second data output pin R1out. The sending terminal TXD is coupled to the first data input pin T1in. The second data input pin R1in and the first data output pin T1out are coupled to the display 70 via a connector 90. The input terminal P2.7 is coupled to the detecting module 10. The output unit P0 is coupled to the indicating module 40. The data reading terminal RD is coupled to the time wire pin SCL. The data writing terminal WR is coupled to the data wire pin SDA.

In the temperature indicating system, the first switch SW1 is configured to control to switch on and switch off the control module 30. The second switch SW2, the third switch SW3, and the fourth switch SW4 are configured to control to switch on and switch off the three Nixie tubes of the indicating module 40, respectively.

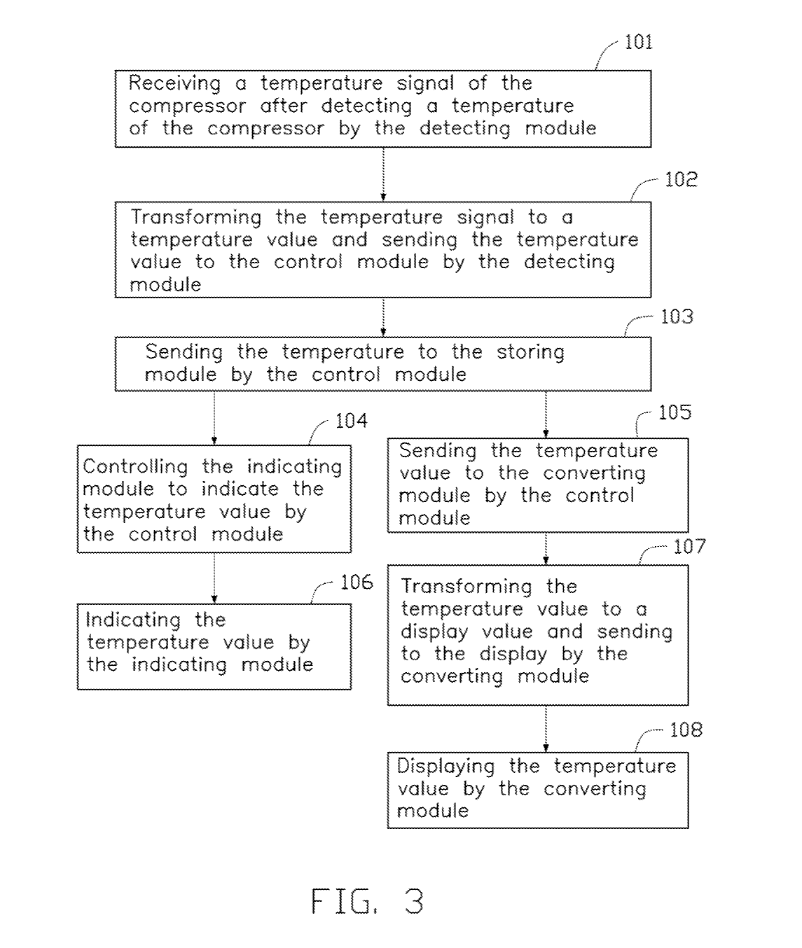

FIG. 3 illustrates a flowchart in accordance with an example embodiment. A method of the temperature indicating system is provided by way of example, as there are a variety of ways to carry out the method. The method of the temperature indicating system described below can be carried out using the configurations illustrated in FIGS. 1 and 2, for example, and various elements of these figures are referenced in explaining the method of the temperature indicating system. In FIG. 3 each block represents one or more processes, methods, or subroutines carried out in the voice-recognition method. Furthermore, the illustrated order of blocks is by example only and the order of the blocks can change. Additional blocks may be added or fewer blocks may be utilized, without departing from this disclosure. The method of the temperature indicating system can begin at block 101.

At block 101, the detecting module 10 receives a temperature signal of the compressor after detecting a temperature of the compressor 80.

At block 102, the detecting module 10 transforms the temperature signal to a temperature value and sends the temperature value to the control module 30.

At block 103, the control module 30 sends the temperature value to the storing module 20 and the storing module 20 stores the temperature value.

At block 104, the control module 30 sends the temperature value to the indicating module 40.

At block 105, the control module 30 sends the temperature value to the converting module 60.

At block 106, the control module 30 controls the indicating module 40 to indicate the temperature value.

At block 107, the converting module 60 transforms the temperature value to a display value and sends the display value to the display 70.

At block 108, the display 70 displays the temperature value.

In one embodiment, the detecting module 10 is a temperature sensor and a style of the temperature sensor is DSDS18B20; a style of the storing module 20 is AT24C08; the control module 30 is a microcontroller and a style of the microcontroller is AT89S52; the indicating module 40 is a liquid crystal display and a style of the indicating module 40 is HS1602; a style of the converting module 60 is MAX232; the power supply module 50 is a USB interface power supply; the control module 30 is communicating with the converting module 60 via a zero modem mode.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. A temperature indicating system comprising:
a detecting module configured to receive a temperature signal after detecting a temperature;
a control module; and
an indicating module,
wherein, the detecting module is also configured to convert the temperature signal to a temperature value and send the temperature value to the control module; and
wherein the control module is configured to control the indicating module to indicate the temperature value after receiving the temperature value.

2. The temperature indicating system of claim 1, wherein the control module comprises an input terminal coupled to the detecting module to receive the temperature value.

3. The temperature indicating system of claim 2, wherein the control module further comprises an output unit coupled to the indicating module to send the temperature value to the indicating module.

4. The temperature indicating system of claim 3, further comprising a converting module, wherein the control module is configured to couple to a display of a computer via the converting module, the control module is configured to send the temperature value to the converting module, and the converting module is configured to transform the temperature value to a display value and send the display value to the display.

5. The temperature indicating system of claim 4, wherein a style of the converting module is MAX232.

6. The temperature indicating system of claim 5, wherein the control module further comprises a sending terminal and a receiving terminal, the converting module comprises a first data input pin, a second data input pin, a first data output pin, and a second data output pin, the receiving terminal is coupled to the second data output pin, the sending terminal is coupled to the first data input pin, and the second data input pin and the first data output pin are configured to couple to the display.

7. The temperature indicating system of claim 6, wherein the control module further comprises a first control terminal, a second control terminal, and a third control terminal, the first control terminal is grounded via a first switch, the second control terminal is grounded via a second switch, the third control terminal is grounded via a second switch.

8. The temperature indicating system of claim 5, wherein the control module is communicated with the converting module via a zero modem mode.

9. The temperature indicating system of claim 1, further comprising a storing module coupled to the control module, wherein the control module is configured to send the temperature value to the storing module to store.

10. The temperature indicating system of claim 9, wherein a style of the storing module is AT24C08.

11. A temperature indicating system comprising:
a detecting module configured to receive a temperature signal after detecting a temperature of a compressor;
an indicating module; and
a control having:
an input terminal coupled to the detecting module; and
an output unit coupled to the indicating module;
wherein, the detecting module is configured to convert the temperature signal to a temperature value after receiving the temperature signal and send the temperature value to the control module;
wherein, the input terminal of the control module is configured to receive the temperature value and the output unit of the control module is configured to send the temperature value to the indicating module; and
wherein the control module is configured to control the indicating module to indicate the temperature value after receiving the temperature value.

12. The temperature indicating system of claim 11, further comprising a power supply module configured to supply power to the control module, and the power supply module is a USB interface power supply.

13. The temperature indicating system of claim 11, wherein the control module is a microcontroller.

14. The temperature indicating system of claim 11, further comprising a converting module, wherein the control module is configured to couple to a display of a computer via the converting module, the control module is configured to send the temperature value to the converting module, and the converting module is configured to transform the temperature value to a display value and send the display value to the display.

15. The temperature indicating system of claim 14, wherein a style of the converting module is MAX232.

16. The temperature indicating system of claim 15, wherein the control module further comprises a sending terminal and a receiving terminal, the converting module comprises a first data input pin, a second data input pin, a first data output pin, and a second data output pin, the receiving terminal is coupled to the second data output pin, the sending terminal is coupled to the first data input pin, and the second data input pin and the first data output pin are configured to couple to the display.

17. The temperature indicating system of claim 16, wherein the control module further comprises a first control terminal, a second control terminal, and a third control terminal, the first control terminal is grounded via a first switch, the second control terminal is grounded via a second switch, the third control terminal is grounded via a second switch.

18. The temperature indicating system of claim 17, wherein the indicating module comprises three Nixie tubes, and the first switch, the second switch, and the third switch are configured to control to switch on and switch off the three nixie tubes, respectively.

19. The temperature indicating system of claim 15, wherein the control module is communicated with the converting module via a zero modem mode.

20. The temperature indicating system of claim 11, further comprising a storing module coupled to the control module, wherein the control module is configured to send the temperature value to the storing module to store.
